(19) United States
(12) Patent Application Publication
(10) Pub. No.: US 2008/0291353 A1
(43) Pub. Date: Nov. 27, 2008

(54) Transformer for Inverter

(76) Inventor: Sang Ok Park, Gwangju (KR)

Correspondence Address: BIRCH STEWART KOLASCH & BIRCH, PO BOX 747, FALLS CHURCH, VA, 22040-0747, US

(21) Appl. No.: 11/630,997

(22) PCT Filed: Jun. 24, 2005
(86) PCT No.: PCT/KR2005/001961

§ 371 Date: Dec. 28, 2006

(30) Foreign Application Priority Data
Jun. 28, 2004 (KR) 10-2004-0049176

(51) Int. Cl. H01F 27/28

(52) U.S. Cl. 349/56; 336/182

(57) ABSTRACT

A transformer for an inverter includes: a bobbin including at least one barrier rib between a pair of opposing side-walls, and a coil winding part divided into a low voltage side and a high voltage side by the barrier ribs, two or more strands of a coil being wound around the coil winding part of the low voltage side; and a ferrite core inserted into the bobbin, the ferrite core surrounding the bobbin and guiding a magnetic flux.

### TECHNICAL FIELD

The present invention relates to a transformer for a lamp driving circuit.

### BACKGROUND ART

An active matrix liquid crystal display device (LCD) displays data by using thin film transistors (hereinafter, referred to as TFTs) as switching elements.

Compared with a cathode ray tube (CRT), the LCD can be scaled down and thus it is widely used in various fields, including a personal computer, a notebook computer, an office automation equipment such as a copier, and a portable equipment.

Since the LCD is not a self-luminous display device, it requires a light source such as a backlight. The backlight is driven by an inverter and dissipates the most power.

The inverter for driving the backlight is divided into a DC/DC transformation part and a DC/AC transformation part.

The DC/DC transformation part can generate a DC voltage by using a pulse width modulation (PWM) scheme and control brightness by modulating a pulse width.

The DC/AC transformation part receives a voltage from the DC/DC transformation part, boosts it to a high AC voltage enough to turn on a lamp, and then maintains a proper voltage.

In the related art inverter for use in the LCD, however, a method for controlling parasitic component of the transformer in the DC/AC transformation part is limited. Therefore, the related art inverter has a problem in that a matching with a circuit cannot be maximized.

FIG. 1 is an assembled perspective view of a related art transformer for use in a lamp driving circuit in an LCD, and FIG. 2 is a sectional view for explaining a winding method of the transformer shown in FIG. 1.

Referring to FIGS. 1 and 2, the related art transformer for the inverter includes a bobbin 10 and ferrite cores 41 and 42. A coil 20 is wound around the bobbin 10 and barrier ribs 11 are regularly formed spaced apart from one another in the bobbin 10. The ferrite cores 41 and 42 are inserted into the central portion of the bobbin 10.

In such a related art transformer, the winding of the coil 20 starts from a left bottom of a left winding part and proceeds to a right direction. When the coil 20 reaches the right barrier rib 11, the winding direction changes in order of 9, A, B, C, D, E. That is, the coil 20 is wound in zig-zag form.

At this time, the coil 20 consists of one strand. Here, the coil 20 represents a coil formed at a low voltage side and reference numerals 21 and 22 represent coils formed at a high voltage side.

The efficiency of the inverter transformer is closely related with the frequency used in the transformer, and the frequency is related to inductance, leakage inductance, and parasitic component. That is, in order to increase the efficiency of the transformer, the inductance, leakage inductance, and the parasitic component must be adjusted properly.

The related art method using a strand of coil 20, however, has difficulty in adjusting them. Thus, resistance increases and heat loss occurs, thereby degrading energy efficiency.

In general, the inverter efficiency of the LCD is about 70-85%. That is, loss component is about 15-30%.

Specifically, the heat generation in the low voltage side is so serious that the lifetime and reliability of the lamp is badly affected.

In order to control the parasitic component, a method of changing the number of turns of the coil 20 or a method of changing the shape of the bobbin 10 has been used. However, if the number of turns of the coil 20 is changed, other characteristics are also changed. Also, in order to change the shape of the bobbin 10, test data for accurate mechanical design are required and expensive mold must be formed again.

A size of the transformer for the inverter used in the LCD is restricted extremely. Therefore, an effective field of the ferrite core is restricted and the ferrite core is easily saturated.

### DISCLOSURE

### Technical Problem

An object of the present invention is to provide a transformer for an inverter capable of maximizing a matching with an inverter circuit by adjusting parasitic component of a transformer, and a winding method thereof.

### Technical Solution

In an aspect of the present invention, there is provided a transformer for an inverter, including: a bobbin including at least one barrier rib between a pair of opposing sidewalls, and a coil winding part divided into a low voltage side and a high voltage side by the barrier ribs, two or more strands of a coil being wound around the coil winding part of the low voltage side; and a ferrite core inserted into the bobbin, the ferrite core surrounding the bobbin and guiding a magnetic flux.

In another aspect of the present invention, there is provided a coil winding method of a transformer for an inverter, the coil winding method including: winding two or more strands of a coil around a coil winding part of a low voltage side of a bobbin; winding a coil around a coil winding part of a high voltage of the bobbin; and coupling ferrite cores to surround the bobbin.

### ADVANTAGEOUS EFFECTS

A transformer for an inverter according to the present invention can minimize a copper loss by winding two or more strands of coil around a low voltage side of a bobbin, and can increase power transfer effect and thus maximize the efficiency of the inverter.

### DESCRIPTION OF DRAWINGS

FIG. 1 is an assembled perspective view of a related art transformer for a lamp driving circuit in an LCD.

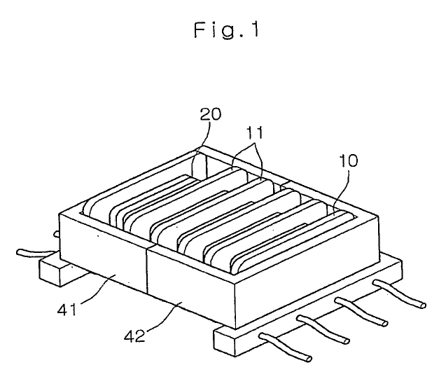

FIG. 2 is a sectional view illustrating a winding method of the transformer shown in FIG. 1.

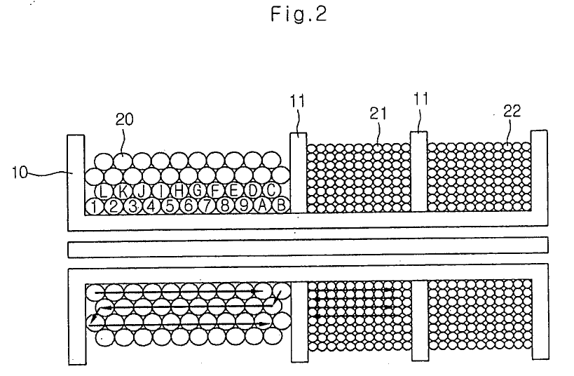

FIG. 3 is an exploded perspective view of a transformer for a lamp driving circuit according to an embodiment of the present invention.

FIG. 4 is a sectional view illustrating a winding method of a transformer for a lamp driving circuit according to an embodiment of the present invention.

FIG. 5 is a sectional view illustrating a winding method of a transformer for a lamp driving circuit according to another embodiment of the present invention.

FIG. 6 is a schematic block diagram of an inverter according to an embodiment of the present invention.

FIG. 7 is a circuit diagram of the inverter shown in FIG. 6.

FIG. 8 is a schematic circuit diagram of a general transformer.

FIG. 9(a) is a circuit diagram illustrating a resistance of a transformer using a related art winding method, and FIG. 9(b) is a circuit diagram of a resistance of a transformer using a winding method according to the present invention.

FIG. 10 is a graph illustrating a relation between an input and output of the inverter.

### BEST MODE

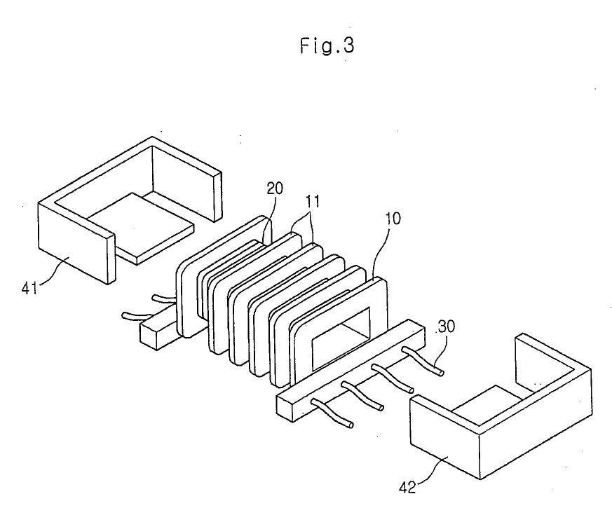

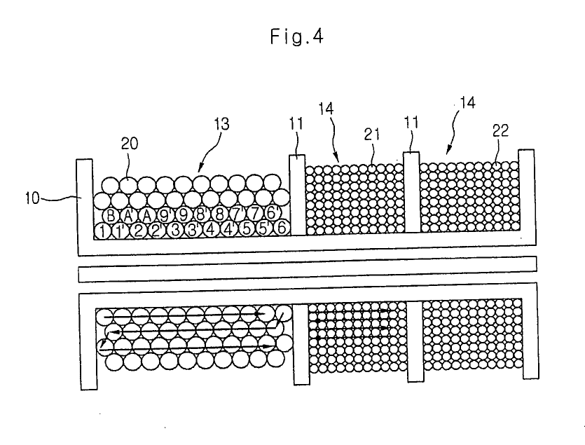

FIG. 3 is an exploded perspective view of a transformer for a lamp driving circuit according to an embodiment of the present invention, and FIG. 4 is a sectional view illustrating a winding method of the transformer for the lamp driving circuit according to an embodiment of the present invention.

Referring to FIGS. 3 and 4, the transformer for the inverter includes a bobbin 10 and ferrite cores 41 and 42. A coil 20 is wound around the bobbin 10 and barrier ribs 11 are regularly formed spaced apart from one another in the bobbin 10. The ferrite cores 41 and 42 are inserted into the central portion of the bobbin 10.

The bobbin 10 having the barrier ribs 11 is an injection molding of LCP or phenol material, and the ferrite cores 41 and 42 is formed of fine oxide of manganese, zinc or nickel and guides a magnetic flux.

The ferrite cores 41 and 42 are formed in E-shape and their central portions pass through the bobbin 10. Sidewalls of the ferrite cores 41 and 42 surround sidewalls of the bobbin 10 around which the coils 20, 21 and 22 are wound.

Although the E-shaped ferrite cores 41 and 42 are used in this embodiment, the present invention is not limited to this configuration, but it can be applied in various manners.

The coils 20, 21 and 22 are differently wound around a low voltage side and a high voltage side according to a predetermined turn ratio and a current flows through them.

At this time, an amount of current flowing in the low voltage side is larger than that flowing in the high voltage side. Thus, heat is generated much in the coil 20 of the low voltage side than in the coils 21 and 22 of the high voltage side. For these reasons, it is preferable that a diameter of the coil 20 of the low voltage side is formed larger than a diameter of the coils 21 and 22 of the high voltage side.

When the coils 21 and 22 of the high voltage side is formed to 0.02-0.04 mm in diameter, the coil 20 of the low voltage side is formed to 0.2-0.4 mm in diameter.

The surfaces of the coils 20, 21 and 22 are covered with an insulating material.

Also, lead pins 30 are formed on both ends of the bobbin 10. The coils 20, 21 and 22 are wound within a winding part 13 between the barrier ribs 11.

Two or more strands of coil 20 are wound around the winding part 13 of the low voltage side of the bobbin 10.

In this case, the respective coil 20 may be wound in an arranged state without any twist, or the coils 20 may be wound in an unarranged state that the coils of the upper layer are interposed between the respective coils 20.

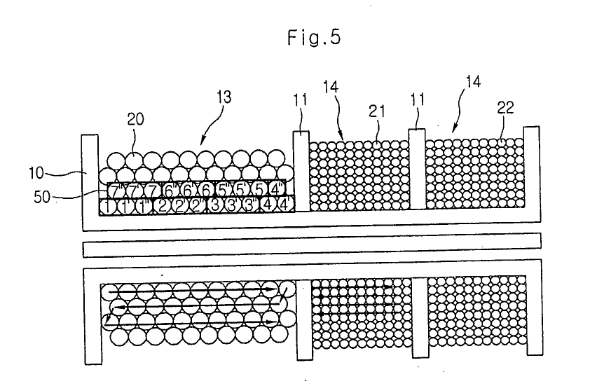

As shown in FIG. 5, in order to effectively wind and manage two or more strands of the coils 20, an integral wire 50 formed by coating two or more strands of coils 20 with an insulating material can be used. Therefore, the winding work is convenient. FIG. 5 is a sectional view illustrating a winding method of a transformer for a lamp driving circuit according to another embodiment of the present invention.

Also, two or more strands of the coils 20 can be wound in a twisted state around the winding part 13 of the low voltage side. Like the embodiment shown in FIG. 5, an integral wire 50 formed by coating two or more strands of coils 20 with an insulating material can be used.

In some cases, two or more strands of the coils 21 and 22 can be wound around winding parts 14 of the high voltage side, just like in the low voltage side.

The coil winding parts of the bobbin 10 with the coils 20, 21 and 22 wound around are taped. After assembling the bobbin 10 with the ferrite cores 41 and 42, the two ferrite cores 41 and 42 are surrounded by an adhesive tape.

In such a transformer, the coil 20 of the low voltage side is wound from a left side to a right side. When the coil 20 reaches the right barrier rib 11, the winding direction changes from the right side to the left side. That is, the coil 20 is wound in zig-zag form.

Due this configuration, coupling coefficient of inductance and leakage inductance can be adjusted. Also, parasitic capacitance such as an inter-winding capacitance between the coils 20 can be easily adjusted to a desired value, thereby maximizing an effect of a matching with the inverter according to the frequency.

An operation of the transformer according to the present invention will be described below.

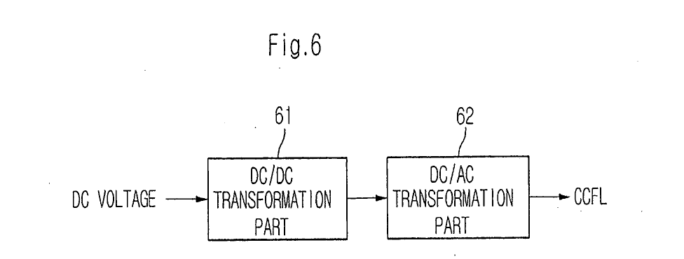

FIG. 6 is a schematic block diagram of an inverter according to an embodiment of the present invention.

Referring to FIG. 6, the inverter for driving the backlight includes a DC/DC transformation part 61 and a DC/AC transformation part 62. The DC/DC transformation part 61 generates a DC voltage suitable for driving the backlight by using a pulse width modulation, and the DC/AC transformation part 62 converts the DC voltage from the DC/DC transformation part 61 into an AC voltage and supplies the AC voltage to a lamp (CCFL).

The DC/DC transformation part 61 performs a pulse width modulation on a DC voltage supplied from a power supply and controls a lamp on period and a lamp off period.

The DC/AC transformation part 62 transforms the voltage supplied from the DC/DC transformation part 61 into a high AC voltage enough to turn on the lamp.

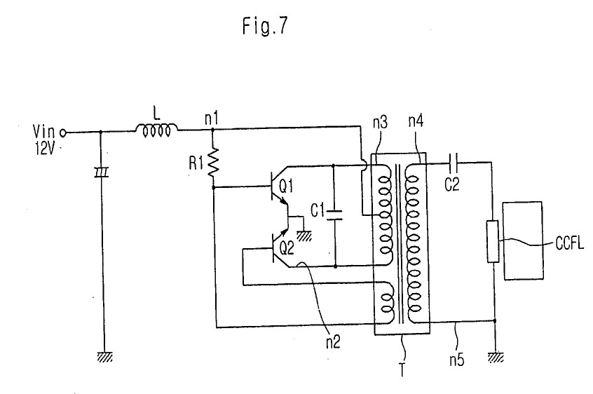

FIG. 7 is a circuit diagram of the inverter shown in FIG. 6. Referring to FIG. 7, the DC/AC transformation part 62 of the inverter includes an inductor L through which a power is supplied from the DC/DC transformation part 61, first and second transistors Q1 and Q2 commonly connected to a first node n1 via a resistor R1 in push-pull type, a first capacitor C1 connected to terminals of the first and second transistors Q1 and Q2, a lamp (CCFL) responsive to a high AC voltage, a transformer T for boosting the voltage across the first capacitor C1, and a second capacitor C2 connected between a coil of a high voltage side and the CCFL.

The amount of heat(Q) generated in the coil of the low voltage side can be expressed as

Q=0.24i²RT

Here, variable parameters are a current (i) and a resistance (R).

If the current (i) is easily adjusted, Q can be efficiently adjusted because Q is proportional to the square of the current (i). In practice, however, it is difficult to adjust the current.

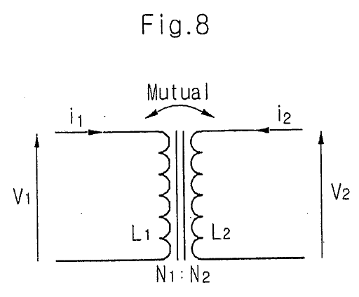

FIG. 8 is a circuit diagram of a general transformer. The transformer follows a following equation.

$$N = \frac{{N}_{1}}{{N}_{2}} = \frac{{V}_{1}}{{V}_{2}} = \frac{{i}_{2}}{{i}_{1}}$$

where N represents a turn ratio.

If the turn ratio is adjusted, a voltage ratio and a current ratio are changed and therefore Q can be adjusted.

However, if the number of turns in one side (the low voltage side or the high voltage side) is changed, the number of turns in the other side is also changed, resulting in the change of the voltage (V).

Accordingly, the resistance (R) is considered as an adjustable parameter.

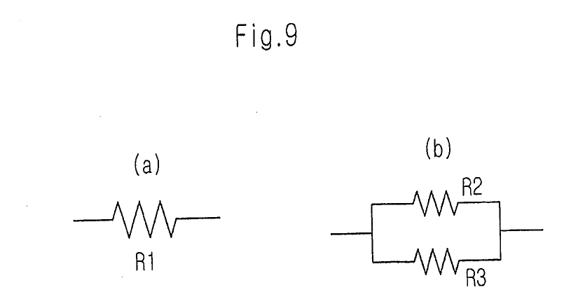

FIG. 9(a) is a circuit diagram illustrating a resistance of a transformer using a related art winding method, and FIG. 9(b) is a circuit diagram of a resistance of a transformer using a winding method according to the present invention.

A total resistance in FIG. 9(a) is given as

Rt₁=R1

A total resistance in FIG. 9(b) is given as

$${Rt}_{2} = \frac{R 2 \times R 3}{R 2 + R 3}$$

If R1=R2=R3, Rₜ₁=2Rₜ₂. Accordingly, the resistance is decreased by half and thus the Q is reduced.

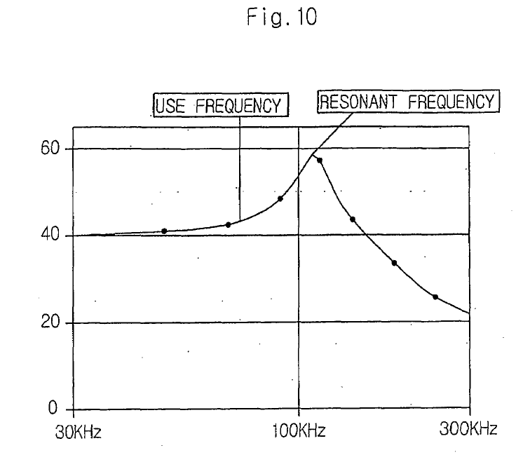

Although the turn ratio must be changed in order to change the current, a magnetic resonant frequency can be changed using the parasitic component of the transformer without changing the turn ratio. Consequently, a gain point can be changed as shown in FIG. 10.

The magnetic resonant frequency of the transformer can be defined as

$$Trans ( srf ) = \frac{1}{2 π \sqrt{LC}}$$

In the above equation, the inductance is a total inductance containing a leakage component, and the capacitance is a total capacitance containing a parasitic capacitance.

Here, a method for changing the resonant frequency without changing the inductance can be proposed.

As described above, if the resonance point is changed, the gain point is also changed. Thus, the matching is achieved at the maximum efficient point desired to be selected and more various changes can be obtained compared with the related art winding methods.

According to the present invention, the coupling coefficient of the inductance and the leakage inductance can be adjusted. The parasitic capacitance such as an inter-winding capacitance between the coils can be easily adjusted to a desired value, thereby maximizing an effect of a matching with the inverter according to the frequency.

Also, the transformer for the inverter according to the present invention can be applied to image display devices such as LCD.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

A transformer for an inverter according to the present invention can minimize a copper loss by winding two or more strands of coil around a low voltage side of a bobbin, and can increase power transfer effect and thus maximize the efficiency of the inverter.

1. A transformer for an inverter, comprising:
a bobbin including at least one barrier rib between a pair of opposing sidewalls, and a coil winding part divided into a low voltage side and a high voltage side by the barrier ribs, two or more strands of a coil being wound around the coil winding part of the low voltage side; and
a ferrite core inserted into the bobbin, the ferrite core surrounding the bobbin and guiding a magnetic flux.

2. The transformer according to claim 1, wherein a surface of the coil is covered with an insulating material.

3. The transformer according to claim 1, wherein the two or more strands of the coil wound around the coil winding part of the low voltage side are not twisted one another.

4. The transformer according to claim 1, wherein the two or more strands of the coil are wound in an arranged state.

5. The transformer according to claim 1, wherein the two or more strands of the coil are wound in an unarranged state.

6. The transformer according to claim 1, wherein the two or more strands of the coil are coated with an insulating layer to thereby form an integral wire.

7. The transformer according to claim 1, wherein the two or more strands of the coil wound around the coil winding part of the low voltage side are twisted each other.

8. The transformer according to claim 1, wherein the ferrite core is provided with one E-shaped pair.

9. The transformer according to claim 1, wherein the coil of the low voltage side has a diameter greater than the coil of the high voltage side.

10. The transformer according to claim 1, wherein two or more strands of a coil are wound around the coil winding part of the high voltage side of the bobbin.

11. The transformer according to claim 1, wherein a coupling coefficient of inductance and leakage inductance, and a parasitic capacitance between the coils are adjusted by the winding of the two or more strands of the coil.

12. A coil winding method of a transformer for an inverter, the coil winding method comprising:
winding two or more strands of a coil around a coil winding part of a low voltage side of a bobbin;
winding a coil around a coil winding part of a high voltage of the bobbin; and
coupling ferrite cores to surround the bobbin.

13. The coil winding method according to claim 12, wherein the two or more strands of the coil are simultaneously wound around the coil winding part of the low voltage side, such that the two or more strands of the coil are not twisted one another.

14. The coil winding method according to claim 12, wherein the two or more strands of the coil are wound in an arranged state.

15. The coil winding method according to claim 12, wherein the two or more strands of the coil are wound in an unarranged state.

16. The coil winding method according to claim 12, wherein the two or more strands of the coil are coated with an insulating layer to thereby form an integral wire.

17. The coil winding method according to claim 12, wherein the two or more strands of the coil wound around the coil winding part of the low voltage side are twisted each other.

18. The coil winding method according to claim 12, wherein two or more strands of a coil are wound around the coil winding part of the high voltage side of the bobbin.

19. The coil winding method according to claim 12, wherein the coils are wound in zig-zag form around the coil winding parts of the low voltage side and the high voltage side.

20. The coil winding method according to claim 12, wherein a coupling coefficient of inductance and leakage inductance, and a parasitic capacitance between the coils are adjusted by the winding of the two or more strands of the coil.

21. An LCD comprising:
a transformer for an inverter including: a bobbin including at least one barrier rib between a pair of opposing sidewalls, and a coil winding part divided into a low voltage side and a high voltage side by the barrier ribs, two or more strands of a coil being wound around the coil winding part of the low voltage side; and a ferrite core inserted into the bobbin, the ferrite core surrounding the bobbin and guiding a magnetic flux;
a lamp driven by a voltage supplied from the transformer; and
a liquid crystal panel for receiving light emitted from the lamp and displaying an image.

22. The LCD according to claim 21, wherein the two or more strands of the coil wound around the coil winding part of the low voltage side are not twisted one another.

23. The LCD according to claim 21, wherein the two or more strands of the coil are coated with an insulating layer to thereby form an integral wire.

24. The LCD according to claim 21, wherein a coupling coefficient of inductance and leakage inductance, and a parasitic capacitance between the coils are adjusted by the winding of the two or more strands of the coil.
